(19) United States
(12) Patent Application Publication
(10) Pub. No.: US 2004/0264092 A1
(43) Pub. Date: Dec. 30, 2004

(54) Electroceramic component

(76) Inventors: Hermann Grunbichler, Graz (AT); Martin Schwingenschuh, Graz (AT)

Correspondence Address: FISH & RICHARDSON PC, 225 FRANKLIN ST, BOSTON, MA, 02110, US

(21) Appl. No.: 10/485,166

(22) PCT Filed: Jul. 4, 2002
(86) PCT No.: PCT/DE02/02457

(30) Foreign Application Priority Data
Aug. 2, 2001 (DE) 101 37 873.4

(51) Int. Cl. H02H 5/04

(52) U.S. Cl. 361/103

(57) ABSTRACT

An electric component with a fuse against overvoltages in which a current path is defined between a first and second electric contact (5, 15) that runs through at least one ceramic base body (1) and an electrically conducting piece (10) in direct thermal contact with the base body and is constructed in such a way that, when the predetermined operating voltage of the component is exceeded, it melts due to the heating of the base body and breaks the current path. Electric flashovers between the regions of the current path that are in contact with the electrically conducting piece (10) are prevented by an electrically insulating material (20)

This invention concerns an electroceramic component with a temperature fuse.

Components of this kind include varistors, for example. The base body of such known components is often produced from a mixture of various metal oxides, for example zinc oxide. Varistors have a non-linear voltage-dependent resistance change that is used to protect an electric circuit from overvoltage. The resistance value of varistors drops, in this case, as the applied voltage increases.

When an overvoltage appears (operating voltage exceeds a permitted limit value for the varistor), the current passing through the varistor rises sharply. The resulting strongly increasing loss heats the varistor up. In that case, a long-lasting overvoltage can lead to overheating and set off a fire.

A varistor fuse element for protecting an electric circuit from overvoltage and overheating is known from printed document DE 331 85 88. It consists of a mechanical construction in which solder with a low melting point is applied to the varistor, which establishes a spring current conductor. When an overvoltage and thereby associated overheating appears, the solder melts, whereupon the spring structure immediately produces an irreversible low-resistance short circuit with a second current conductor. In this case, the spring structure also increases the distance between the spring current conductor and the varistor, in order to prevent an electric flashover. The disadvantages of this mechanical structure are in the fact that it can be achieved only at great cost.

In printed document JP 04 151 804 A, a temperature fuse is disclosed, that is integrated into a varistor housing, and that is connected through an electric line to an internal electrode of the varistor. The temperature fuse, in this case, is surrounded by a material that permits heat to be conducted between the varistor and the temperature fuse. In case of overheating of the varistor due to long-lasting overvoltage, the heat of the varistor can thereby be transferred to the temperature fuse and trigger it. The disadvantage of this structure is that the temperature fuse is not in direct thermal contact with the varistor, and, therefore, because of losses during heat transfer, the fuse is triggered only at higher temperatures.

This invention is therefore based on the goal of making a simple thermal fuse for electroceramic components available that avoids the aforementioned disadvantages.

This goal is achieved by the characteristics of Claim 1. Advantageous embodiments of the invention are the object of additional claims.

The invention relates to an electroceramic component with at least a first ceramic base body. In normal operation, in which the operating voltage does not exceed a predetermined limit value, a current flow occurs between two electrical contacts through the first ceramic base body and an electrically conducting piece. The first ceramic base body contacts the electrically conducting piece and is therefore in direct heat contact with it. When the operating voltage is exceeded, the first ceramic base body heat up strongly due to the increasing loss, so that the electrically conducting body is also heated up. It is implemented in such a way that it melts beyond a certain temperature, and the current flow is thereby interrupted. An electrically insulating material prevents an electric flashover between the electrically conducting regions contacted by the electrically conducting piece and thus assures a reliable interruption of the current path.

The advantages of this invention over the state of the art are that the electrically conducting piece according to the invention is in direct heat contact with the first ceramic base body. Because of this, no heat transfers associated with losses will occur through enclosing the first surrounding body. The overheating fuse can therefore be triggered at low temperatures at the first base body, and it is therefore significantly more sensitive than traditional fuses. Another advantage is that, after the electrically conducting piece melts, an electric flashover can be prevented in a simple way according to the invention by the electrically insulating material. No expensive mechanical spring structures are necessary to move the contacts away from each other after the electrically conducting piece melts.

The first base body can contain, for example, a varistor ceramic based on zinc oxide. The electrically conducting piece is advantageously a solder with a low melting point, for example, a melting point between about 80° C. and 180° C. Materials that can drizzle or flow, such as quartz sand or glass balls, can be used as the electrically insulating material.

This has the advantage that the material that can drizzle or flow can penetrate into the liquid metal after the electrically conducting piece, the solder, melts, and thus the formation of an arc light and thereby a flashover can be reliably prevented.

Advantageously, an encapsulation, for example of a heat-resistant plastic such as polyphenylene sulfide (PPS), can be provided that creates a container for the insulating material that can drizzle or flow and thereby simultaneously increase the mechanical stability of the component.

The entire electroceramic component with the integrated temperature fuse and the encapsulation can be surrounded advantageously with a single housing. In this way, a compact component with low space requirement is formed.

In the following, the invention will be explained in more detail with reference to the diagrams of embodiment examples.

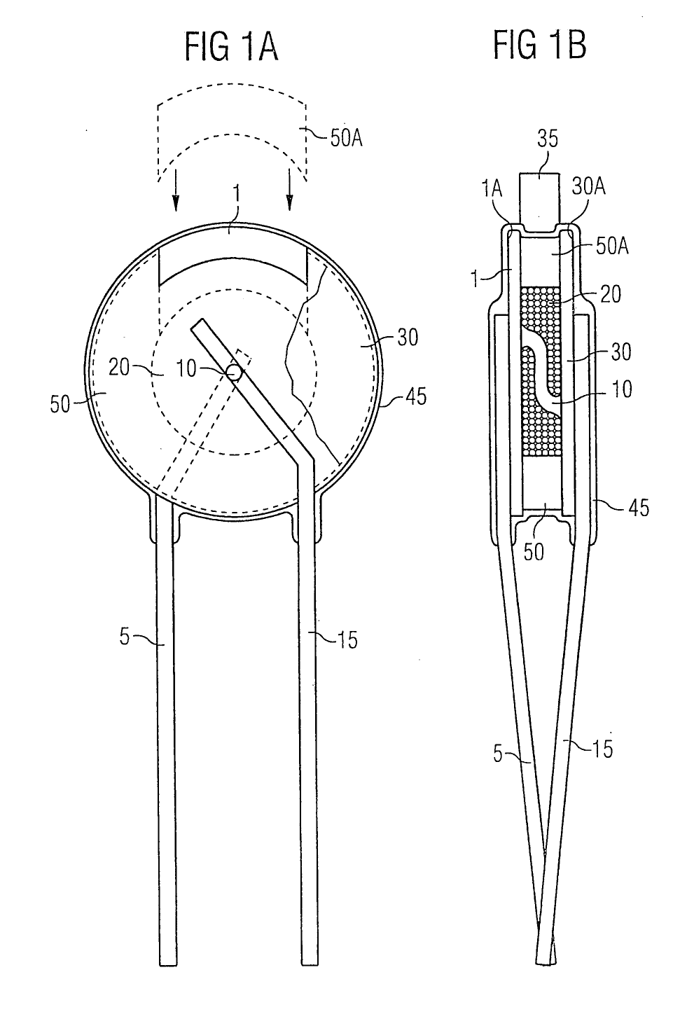

FIGS. 1A and 1B show a varistor according to the invention with an integrated temperature fuse with two ceramic base bodies, in a top view and in cross-section.

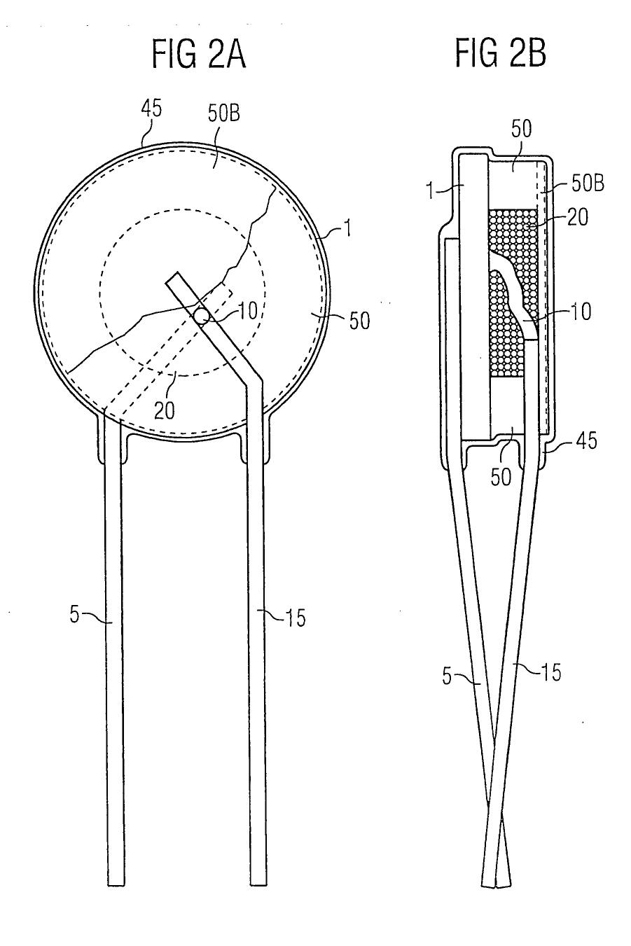

FIGS. 2A and 2B show a varistor according to the invention with only one ceramic base body, in a top view and in cross-section.

In FIGS. 1A and 1B, a series circuit with two varistor base bodies 1 and 30, each with an operating voltage of about 60 to 75 V, is shown, so that a total operating voltage of about 130 V can be achieved. The two varistor base bodies 1 and 30 are connected to each other in an electrically conducting manner by the electrically conducting piece 10, a low-melting solder with a melting point of about 80° C. to 180° C. The electrically insulating material 20 can be implemented advantageously as quartz sand, which is arranged between the two varistor base bodies and surrounds the solder 10. Tinned copper wires, for example, can serve as electric contacts 5 and 15. A plastic ring 50, advantageously made of a heat-resistant plastic such as polyphenylene sulfide (PPS), together with the two ceramic base bodies 1 and 30 as a lid, creates a hollow space for the insulating material 20. The hollow space can be closed by a stopper 50A. To prevent external flashovers, the entire component with an integrated temperature fuse can be surrounded advantageously by a housing 45 consisting, for example, of epoxide plastic.

In case of a strong overvoltage, the electrically conducting piece 10 of the component melts reliably within a few seconds. At the time of the triggering of the temperature fuse, the temperature at the housing of the component is only about 120° C.

By this means, it is assured that the component does not start to bum and also that no object in its environment catches fire. At the same time, by using a solder wire about 1 mm thick, current surges of some 8000 A (impulse form 8/20 μs) can be withstood. This means that with the overheating fuse according to the invention, no costs need to be taken into account for a current bypass.

To modify the electric characteristics of the varistor according to the invention, it is also possible to use two different varistor materials 1 and 30, for example, based on SiC.

The embodiment with the two ceramic base bodies also has the additional advantage that a spatial separation of the electrical contacts 5 and 15 from the electrically conducting piece 10 is possible. The electrically conducting piece is located in the intermediate space 35 between the two varistor base bodies, whereas the electrical contacts contact the sides 1A, 30A, facing the intermediate space in each case. Thereby, good thermal screening of the electrically conducting piece from the electric contacts is provided so that a high resistance to heat from the solder is provided. By this means, in contrast to many traditional temperature fuses, problem-free soldering or welding of the electric contacts is possible without triggering the temperature fuse.

FIG. 2A shows a top view of, and FIG. 2B a cross-section through, a varistor according to the invention with only one varistor base body 1. In this case, the electrically conducting piece 10 is in direct electric contact with the second electric contact 15 and the varistor base body 1. A ring 50, advantageously made of plastic, creates a hollow space to receive the electrically insulating material 20, which, in this embodiment, is to prevent an electric flashover between the varistor base body 1 and the second electric contact 15. The whole arrangement can be provided with a cover 50B that closes the component. In addition, the varistor base body 1 is contacted by the first electric contact 5.

This alternative embodiment shows similar characteristics in the case of overheating and similar current-diverting ability to that of the embodiment with two ceramic base bodies.

The invention is not limited to the embodiment examples that have been described concretely. Within the framework of the invention, there are obviously many additional variations, especially in regard to the number of ceramic base bodies used, their arrangement with respect to each other, and the type of ceramic materials used.

1. An electric component comprising:
a first base body that connects to a first contact;
an electrically conducting element positioned along a current path between the first contact and a second contact the electrically conducting element melting when an operating voltage of the electric component is exceeded; and
an electrically insulating material substantially surrounding the electrically conducting element and arranged so as to prevent an electric flashover between regions of the current path that are bridged by the electrically conducting element.

2. The electric component of claim 1, wherein:
the electrically conducting element is connected to the second contact; and
the electrically insulating material is arranged between the first base body and the second contact.

3. The electric component of claim 1, wherein:
the electrically conducting element connects the first base body to a second base body (30);
the first contact on the first base body and the second contact is on the second base body; and
the electrically insulating material is between the first and second base bodies.

4. The electric component of claim 1, wherein the electrically conducting element is thermally insulated from the first and second contacts.

5. The electric component of claim 3, wherein:
the first and second base bodies are bundled;
the electrically conducting element is in a space between the first and second base bodies; and
the first and second contacts contact the first and second base bodies, respectively, on sides of the first and second base bodies that face the space.

6. The electric component of claim 3, further comprising a shell that creates and encloses a hollow space for the electrically insulating material.

7. The electric component of claim 6, wherein in the shell is heat resistant.

8. The electric component of claim 6, further comprising a housing that surrounds the first and second base bodies the electrically conducting element the electrically insulating material, and the shell and that at least partially surrounds the first and second contacts.

9. The electric component of claim 3, wherein the first and second base bodies include a varistor ceramic.

10. The electric component e of claim 9, wherein the varistor ceramic comprises ZnO.

11. The electric component of claim 1, wherein the electrically insulating material can drizzle or flow.

12. The electric component of claim 1, wherein the electrically insulating material comprises quartz sand or glass balls.

13. The electric component of claim 1, wherein the electrically conducting element comprises solder.

14. The electric component of claim 1, wherein the electrically conducting element comprises solder with a melting point between about 80° C. and 180° C.
